(19) United States
(12) Patent Application Publication
(10) Pub. No.: US 2016/0207696 A9
(43) Pub. Date: Jul. 21, 2016

(54) SINGLE SERVE CAPSULE FOR IMPROVED EXTRACTION EFFICIENCY AND FAVOR RETENTION

(71) Applicants: Liberatore A. Trombetta, Ancaster (CA); YuCheng Fu, Guelph (CA); Daud Ahmed Khan, Whitby (CA)

(72) Inventors: Liberatore A. Trombetta, Ancaster (CA); YuCheng Fu, Guelph (CA); Daud Ahmed Khan, Whitby (CA)

(21) Appl. No.: 14/188,929

(22) Filed: Feb. 25, 2014

Related U.S. Application Data
(60) Provisional application No. 61/768,873, filed on Feb. 25, 2013.

(51) Int. Cl. B65D 85/804; A23F 5/24; A23F 5/26

(52) U.S. Cl. CPC B65D 85/8043; A23F 5/262; A23F 5/243

(57) ABSTRACT

Disclosed is a single-serve capsule for improved extraction efficiency and flavor retention. Extraction efficiency is improved by using ground roast coffee having an average particle size in the range of from 300 to 800 μm. Flavor retention is improved by using a filter medium made of a synthetic polymer. The capsule can be used in a process in which optimum extraction is obtained during relatively short brew times.

### BACKGROUND

1. Field

The invention relates generally to improved single serve capsules, and more particularly to single serve capsules having improved extraction efficiency and reduced loss of flavor components.

2. Description of the Related Art

In recent years single serve coffee capsules have become very popular, due to the offered convenience and flexibility. Consumers of single serve coffee capsules have come to appreciate the possibility of enjoying freshly brewed coffee of a preferred flavor on the spur of the moment.

Manufacturers of coffee brewers for single serve coffee capsules have uniformly opted for short brewing times, typically less than 90 seconds, and frequently 60 seconds or less, because market research shows that brewing times significantly longer than 90 seconds are not accepted by the broad consumer population, as being an anathema to the convenience aspect of the on-demand single serve concept. However, short brewing times result in sub-optimal extraction of the ground roast coffee.

The single serve approach lends itself well for espresso style coffees, which are traditionally prepared in single serve format, with relatively short brewing times. The espresso brewing process compensates for the short brewing time by using a very fine grind size (typically about 300 μm). Pressurized hot water at 8-10 bar is used to force the hot water through the compacted finely ground coffee. The resulting coffee is very strong, and has a characteristic taste profile that certain consumers dislike. The strength can be, and sometimes is reduced by dilution with hot water, but dilution does not change the taste profile.

Many consumers prefer the more mellow taste of drip filter coffee over the more bitter taste of espresso style coffees. Single-serve capsules have been developed that mimic the drip filter brewing process. These capsules contain ground roast coffee in a first chamber, and a second chamber that is empty. A filter medium separates the second chamber from the first chamber. During the brewing process hot water is injected into the first chamber. Brewed coffee is collected in the second chamber, and from there it is channeled to a beverage container, such as a cup or mug. The filter medium prevents coffee grounds from being entrained with the brewed coffee.

In North America these filter style capsules are far more popular than capsules for espresso style coffees. Filter style capsules suffer from two important drawbacks. Firstly, the short brewing times used in single serve machines results in a sub-optimal extraction of the ground roast coffee. Secondly, the filter material, which typically is made of paper, removes and retains important flavor components from the brewed coffee.

The present invention addresses these problems by providing a single serve coffee capsule enabling improved extraction efficiency of ground roast coffee, while reducing the loss of flavor components through absorption by the filter medium.

Another aspect of the invention comprises a process for brewing coffee using the inventive capsule.

Yet another aspect of the invention is brewed coffee produced by the process of the invention.

### SUMMARY

The invention relates to a single serve coffee capsule comprising a first chamber comprising ground roast coffee having an average particle size in the range of from 300 to 800 μm; and a second chamber; said first chamber being separated from the second chamber by a filter medium made of a synthetic polymeric material.

Another aspect of the invention is a process of brewing coffee using the single serve coffee capsule of the invention, said process comprising passing hot water through the ground roast coffee during a brew time of from 20 to 90 seconds.

Yet another aspect of the invention is coffee produced by the process of the invention.

### DRAWINGS

The drawings included herewith are for illustrating various examples of articles, methods, and apparatuses of the present specification and are not intended to limit the scope of what is taught in any way. For simplicity and clarity of illustration, where considered appropriate, reference numerals may be repeated among the drawings to indicate corresponding or analogous elements.

FIG. 1 is a sectional view of a single serve capsule in accordance with the present invention disposed in a schematic representation of a brew chamber for a beverage preparing machine;

FIG. 2 is enlarged schematic view of a section of filter for a single serve capsule in accordance with the present invention;

FIG. 3 is an enlarged schematic sectional view of a multi-component fiber for the filter shown in FIG. 2; and

FIG. 4 is a sectional view of a single serve capsule in accordance with the present invention showing the multilayered material and the process for forming the filter.

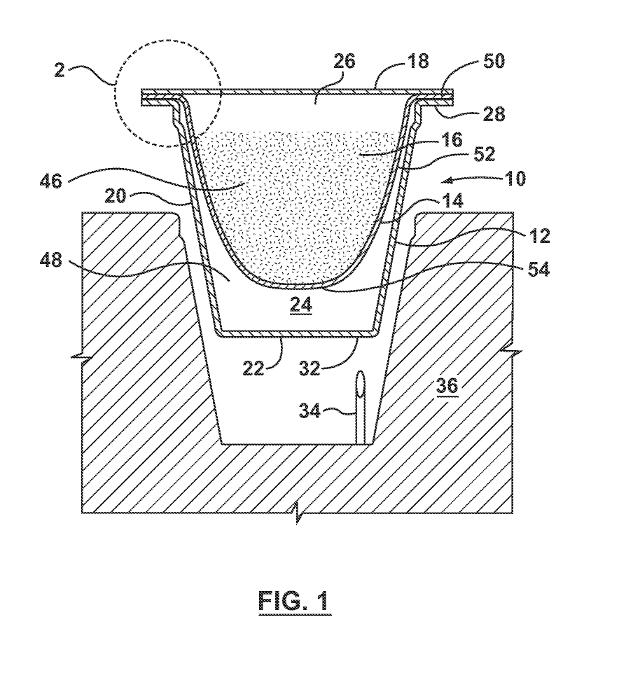

### DETAILED DESCRIPTION OF AN EXEMPLARY EMBODIMENT

The following is a detailed description of the invention.

In one aspect the invention provides a single serve capsule 10 comprising a body 12, filter 14, ingredients 16 and cover 18. Body 12, filter 14 and cover 18 are all formed of food grade materials (meaning materials that are considered to be safe for preparation of food products). Body 12 and cover 18 are each formed of multilayered materials that include one or more barrier layers providing barriers against one or more environmental factors such as light, oxygen, and moisture.

Body 12 includes a side wall 20 and an end wall 22 together defining an interior space 24. An opening 26 is defined at one end of body 12. A flange 28 extends around the perimeter of opening 26. End wall 22 includes an extraction region 32 adapted for being pierced by an extraction needle 34 of a beverage preparing machine 36.

Filter 14 is adapted to be disposed within body 12 to define at least one ingredients chamber 46 in an upper region of the interior space 24 for receiving one or more ingredients 16 and at least one extraction chamber 48 exterior to the ingredients chamber 46 in the interior space 24 for receiving beverage from the at least one ingredients chamber 46 prior to extraction using the extraction needle 34.

Filter 14 includes a gasket portion 50 that is adapted to be disposed between flange 28 and cover 18. Filter 14 also includes a filter portion 52 located inwardly from gasket portion 50 that is adapted to be molded to a desired shape for filtering a beverage from ingredients 16.

In an alternative embodiment (not shown), body 12 does not include a side wall 20 and end wall 22 that define interior space 24. Body 12 instead comprises a structure that is adapted to support filter 14 and also support capsule 10 in beverage preparing machine 36 without fully enclosing filter 14. The structure may comprise flange 28 either on its own or in combination with a partial side wall 20.

Filter 14 may be secured to either the top of flange 28 (preferable) or to side wall 20. Flange 28 may be sized to support capsule in beverage preparing machine 36. Cover 18 may be secured to flange 28, directly or over filter 14, as described herein.

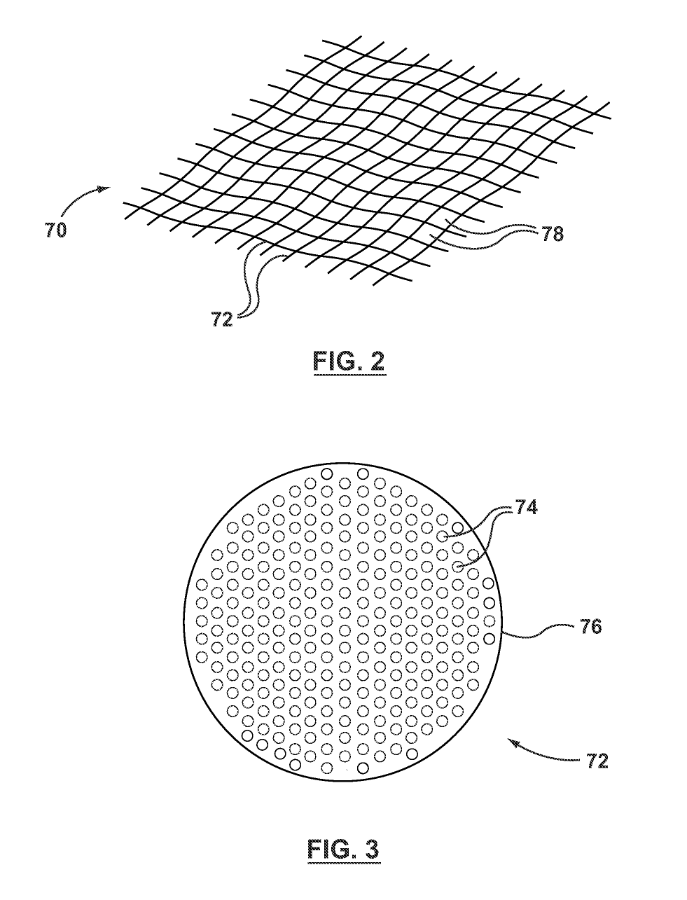

Referring to FIGS. 2 and 3, filter 14 is formed of a moldable non-woven fabric 70 having a basis weight in the range of 40 to 150 grams per square meter (gsm) and more preferably between 60 to 120 gsm.

Fabric 70 is comprised of filaments or fibers 72 (referred to as fibers 72 hereafter) having a single component (homo-component) or multiple components (multi-component). Multi-component fibers 72 may have components arranged in configurations such as islands-in-the-sea, sheath-core or segmented pie. Preferably, fibers 72 comprise two components (bi-component) formed of a first material 74 and a second material 76. The bi-component fiber 72 may be arranged in an islands-in-the-sea configuration with first material 74 forming islands and second material 76 forming a sea as shown in FIG. 3. It will be seen that multiple strands of first material 74 form islands within the sea formed by second material 76.

First material 74, preferably has a higher tensile strength than second material 76 to provide sufficient integrity and strength to fabric 70. First material 74 also preferably has a higher melt temperature than the melt temperature of second material 76. First material 74 also preferably has a higher melt temperature than the melt temperature of the sealing layer of body 12 and the sealing layer of cover 18.

This allows gasket portion 50 of filter to be secured to flange 28 and cover 18 by way of a heat seal that melts second material 76 and the sealing layer of flange 28 while maintaining a web of first material 74 defining channels 78. Channels 78 are adapted to receive molten material from sealing layers for flange 28 and cover 18 during heat sealing to sandwich and seal gasket portion 50 of filter 14 between flange 28 and cover 18.

First material 74 is preferably selected from polyamide (PA) such as nylon, polyethylene terephthalate (PET) and polyester such as polybutylene terephthalate (PBT) or polylactic acid (PLA). More preferably first material 74 is formed from PBT. Second material 76 is preferably selected from polyethylene (PE), polypropylene (PP) and PA. More preferably second material is formed from PE. It is preferable that first material 74 comprises at least 50% of the fibers 72 and more preferable that first material 74 comprises at least 70% of the fibers 72.

Fabric 70 preferably comprises undrawn or partially drawn fibers 72 in order that fibers 72 have the capability to be drawn sufficiently during the filter molding process to form a desired depth of filter 14. Fibers 72 may for instance be formed by melting and spinning selected polymers at low air drawing and/or low spinning speeds. It is preferred that a lower spinning speed is selected to optimize the amount of undrawn or partially drawn fibers.

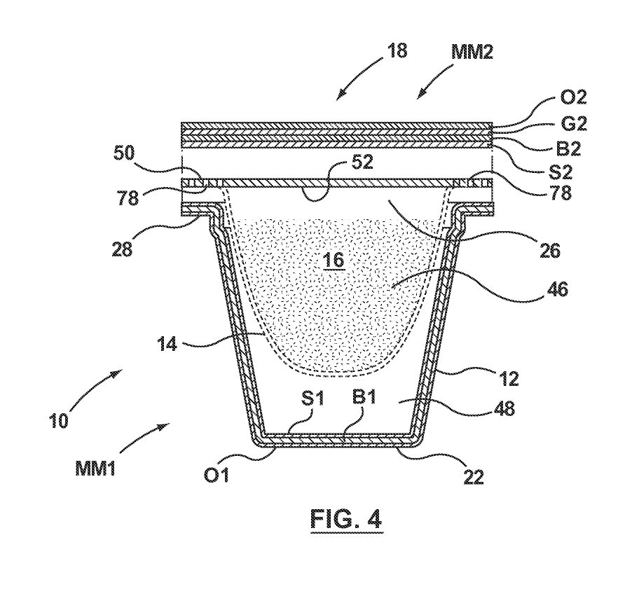

Referring to FIG. 4, an exploded sectional view of a single serve capsule 10 in accordance with the present invention is shown.

Single serve capsule 10 includes body 12 formed of a conventional multilayered material MM1 that includes a barrier layer B1 preferably formed of ethylene vinyl alcohol (EVOH) and a sealing layer S1 preferably formed of polyethylene (PE). As well, body 12 may include outer base layer O1 preferably formed of polyolefin or polyester or other materials adapted to cover and protect barrier layer B.

Single serve capsule 10 further includes cover 18 formed of a conventional multilayered material MM2 that includes a barrier layer B2 preferably formed of aluminum foil or metalized polyester or EVOH and a sealing layer S2 preferably formed of polyolefin. As well, cover 18 may include an outer base layer O2 preferably formed of polyolefin or polyester and a graphics layer G2 preferably formed of ink.

Filter 14 is formed by disposing fabric 70 over opening 26 of body 12. Gasket portion 50 of filter 14 engages sealing layer S1 disposed on the top surface of flange 28 and filter portion 52 extends across opening 26. Gasket portion 50 is then sealed with a heat sealer (not shown) to sealing layer Si disposed on the top surface of flange 28. A portion of the sealing layer S1 on top surface of flange 28 and a portion of second material 76 of fabric 70 is melted by heat sealer and flows into channels 78 within gasket portion 50 of fabric 70. Once the melted material sufficiently cools to support gasket portion 50 on flange 28, then filter 14 may be molded for instance by engaging filter portion 52 using a heated mandrel (not shown) to mold filter portion 52 to a desired shape within interior space of body 12 to form the ingredients chamber 46. Then ingredients 16 are disposed within ingredients chamber 46 of filter 14 and cover 18 is positioned over gasket portion 50 to cover opening 26.

Cover 18 may then be partially sealed to gasket portion 50 using a heat sealer. A portion of the sealing layer S2 on bottom surface of cover 18 and a portion of second material 76 of fabric 70 is melted by heat sealer (not shown) and flows into channels 78 of gasket portion 50. The air within interior space 24 of capsule 10 may then be evacuated and replaced with an inert gas such as nitrogen. Cover 18 may then be fully sealed to body 12 over gasket portion 50 to seal the interior space 24 of capsule 10. In particular, cover 18 may be heated to the melt temperature of sealing layer S so that the material of sealing layer S2 and second material 76 of fabric 70 at least partially flows into channels 78 of gasket portion 50 to form a seal upon cooling. Fibers 72 may be bonded together mechanically, thermally or chemically. Preferably, fibers 72 are mechanically bonded through hydroentanglement or needle punching. More preferably, fibers 72 are mechanically bonded through hydroentanglement.

In one aspect, a single serve coffee capsule 10 is provided with a first chamber 46 comprising ground roast coffee having an average particle size in the range of from 300 to 800 μm. First chamber 46 being separated from the second chamber 48 by a filter medium 14 made of a synthetic polymeric material.

The invention addresses the flavor deficiencies of prior art filter style single serve coffee capsules in two ways: (i) by optimizing the extraction process; and (ii) by minimizing the loss of flavor components through absorption by the filter medium.

With at least about 800 flavor components present in roast ground coffee, the flavor profile of coffee is far from completely understood. But a few general rules can be stated nevertheless. The world's most important coffee species are Arabica and Robusta. Of the two, Arabica is considered having the fuller and more pleasant flavor profile. Coffee beans contain a significant amount of lipids; 15-18% in the case of Arabica; 8-12% in the case of Robusta.

Many components of the lipids fraction are flavor components in their own right. The roasting process contributes to the flavor profile by chemical conversion of such components, for example esterification. Other, more volatile flavor components are not part of the lipid fraction, but are soluble in the lipid fraction.

Brewing coffee involves extraction of flavor and other components from ground roast coffee, using hot water as the extractant liquid. The water temperature is generally in the range of 85 to 100 ° C., more typically between 90 and 95° C. This temperature is high enough for the water to extract a major portion of the lipids from the ground roast coffee. The lipids in the brewed coffee contribute to the flavor experience in three distinct ways. Firstly, the lipids play a major role in defining the mouth feel and texture of the brewed coffee. Secondly, many of the lipids, in particular the esters, are flavor components in their own right. Thirdly, the lipids act as a solvent for many of the coffee flavor components, thereby aiding in the extraction of these components from the ground roast coffee, and preventing their premature evaporation from the brewed coffee. From this perspective it is not surprising that Arabica, which has the higher lipid content, is also the more flavorful.

The extractable solids of ground roast coffee are defined as all non-volatile components of the ground roast coffee that can be removed by extraction. This term includes the non-volatile lipids. Many of the extractable solids can be extracted with hot water, although some require extensive boiling in water to become extracted. Yet other extractible solids require an organic solvent, such as hexane, for extraction. Some of the more difficultly extracted components impart unpleasant flavors, such as bitter notes and astringent notes, to the brewed coffee.

The maximum amount of solids in roast coffee that can be dissolved in water is about 30%. For the best coffee flavor the extraction should be sufficient to capture all the desirable flavor components in the brewed coffee, yet should be gentle enough to avoid over-extraction of the unpleasant bitter and astringent flavor components. It has been found that the best flavor profile of the brewed coffee is obtained in a brewing process whereby from 18 to 22% of the solids are extracted from the ground roast coffee. Extraction within this range will be referred to as “optimum extraction.” Extraction resulting in less than 18% of the extractible solids being extracted will be referred to as “underdeveloped.” Extraction resulting in more than 22% of the extractible solids being extracted will be referred to as “over extraction.” Together with the amount of water used to extract the coffee solids, the coffee strength, which is the ratio of dissolved coffee solids to water in the finished coffee, need to be optimal (1.0-1.5%) in order to achieve a good/gold cup of coffee with the optimum balance of strength and extraction.

In the context of filter style single serve coffee capsules it is difficult to accomplish extraction within the optimum range because the brewing times are kept short for reasons of, real or perceived, consumer preference. The present invention optimizes extraction efficiency by using ground roast coffee having an average particle size in the range of from 300 to 800 μm. Preferably the average particle size is in the range of 400 to 600 μm.

Desirably the ground roast coffee has a narrow particle size distribution, with at least—80% of the particles having a particle size within two standard deviations of the average particle size. The preferred ground coffee particle size is designed to work with the selected filter and limited brew time to maximize a desirable extraction—if coffee is too fine, over extraction is readily induced while under optimal extraction occurs if coffee is too coarse.

It will be understood that an optimized particle size within the ranges defined herein does not necessarily result in optimum extraction. Other factors, such as water temperature, water hardness, and the like also play a role. The optimized particle size/distribution in any event moves the extraction process closer to the optimum, and thereby contributes to the flavor of the brewed coffee.

It has been found that the pore size of the filter medium also contributes to the extraction efficiency. Preferred are filter media having an average pore size in the range of from 50 to 100 μm.

The coffee dosage is also critical in order to achieve gold standard cup based on preferred strength, cup size and extraction level.

According to consumers' preference on brew strength, the ideal coffee dosage is determined through the following equation (the calculation is based on a determined brewing system, i.e., water temperature, pressure, volume, and dispensing pattern are fixed):

$$x = \frac{v \times s}{e}$$

Here, x is the dosage level, v is brew volume, s is preferred total dissolved solid strength, and e is the extraction yield.

Yet another important variable for extraction efficiency is the ratio of the surface area, A, of the filter medium, and the weight W of the ground roast coffee contained in the capsule. Preferably the ratio A/W is in the range of 1 to 10 cm²/g, more preferably from 3 to 7 cm²/g.

Many of the advantages of an optimized extraction efficiency are lost if major flavor components are subsequently lost from the brewed coffee. It has been found that paper, which is commonly used as filter medium in filter style single serve coffee capsules, acts to remove and/or retain a significant portion of the flavor components from the brewed coffee due to the high absorbing capability of cellulose fibers and the relative large filter surface area compared to the packed coffee weight in a single capsule. The pores with filter paper becomes smaller as well especially with expanded cellulose fibers in hot water, which stops desirable molecules including flavor compounds and lipids from passing through the filter. This is, in fact surprising. Although it has been known for some time that filter paper is capable of removing coffee components by absorption, the impact of filter paper on the flavor of single serve coffee has been misunderstood and underappreciated.

This point is illustrated by the disclosures of U.S. Patent Application Publication 2005/0051478 to Karanikos et al. This patent application, which is assigned to North America's leading manufacturer of single serve coffee capsules, seeks to increase the flavor impact of the brewed coffee by using a pleated paper filter instead of a smooth paper filter. Of course, the use of a pleated filter increases the amount of paper, resulting in an increased loss of flavor components through absorption.

The capsule 10 of the present invention uses a filter medium 14 made of a synthetic polymeric material. It has been found that brewed coffee made with a capsule 10 of the invention contains on average 100% more lipid than brewed coffee made with a comparable capsule containing a conventional paper filter.

The filter medium 14 can be any type of porous structure. Non-limiting examples include: a nonwoven web of synthetic fibers; a molded filter basket; a cage of structurally rigid material, covered with a porous polymer web or file; and the like. Any food grade polymer material can be used for the filter medium 14. Preferred materials include polyolefin fibers; polyester fibers, polyamide fibers, and combinations of aforementioned fibers. The fiber here is a generic term which can be short fibers (fibers) or long fibers (filaments). The filter medium can also be a continuous polymeric sheet/film with perforated holes. Preferred materials also include polyolefin, polyamide and polyester. The synthetic filter material is also preferred more hydrophobic than cellulose fibers, through which the filter creates more resistance or back pressure to extractant water. Therefore, more turbulence is generated in a capsule that allows more uniform and efficient extraction.

The filter medium 14 is particularly suitable for the preparation of beverages and other liquid food items, such as sauces and soups. In general, the filter medium 14 serves to retain solid food items from which flavor components; natural colorants; and/or nutritional components are extracted by a liquid. The liquid can be water, in particular hot water. It is also possible to use ethanol as the extracting liquid in the preparation of flavored alcoholic beverages.

There is no limit to the type of solid items from which components can be extracted. Examples for beverage preparation include tea leaves, tea cuts and ground roast coffee. Examples for food item preparation include dried vegetables, such as onions, garlic, carrots, or the like, for the preparation of soups or broths; solid preparations containing food additives, such as vitamins or so-called nutritionals, for the preparation of fortified liquid food items; and pharmaceutically active materials. For example, the filter medium 14 can contain cold medication, such as aspirin and ephedrine, optionally fortified with vitamin C, for the preparation of a hot drink for use in battling the symptoms of the common cold.

Another aspect of the invention is a process for brewing coffee using the single serve coffee capsule of the invention, said process comprising passing hot water through the ground roast coffee during a brew time of from 20 to 90 seconds. It will be understood that larger brew sizes require longer brewing times. The brew time is not a critical portion of this invention, as it is governed by taste preferences, local habits, available brewing equipment and the like.

It should be noted that the process can be carried out with a conventional single serve brewing apparatus as available on the market for filter style single serve coffee. The advantages of the present invention can be achieved without requiring a change in consumer habits or any modification to standard brewing equipment.

Preferably the hot water temperature is in the range of from 90 to 95° C.

In an embodiment the process results in extraction of 18 to 22% of the extractible solids from the ground roast coffee.

In an embodiment the process results in a brewed coffee that meets the international standard for brewed coffee known as the SCAA Gold Cup Standard.

Another aspect of the invention is brewed coffee produced by the process of the invention.

### EXAMPLE

Several batches of coffee were brewed, using a commercially available single-serve coffee maker (Keurig B150). In each test a side-by-side comparison was made between a capsule having a filter made of paper, and a capsule made of a nonwoven web of polyolefin/polyester composite fibers. The brew sizes were varied between tests, but kept constant within each test run so as to provide comparisons having the filter material as the only variable.

Samples of brewed coffee were analyzed for fat content by two different methods.

### A. Total Fat

A sample of brewed coffee is extracted with an organic solvent, such as n-hexane. After extraction the two phases are allowed to separate, after which the organic phase is collected. The organic solvent is evaporated, and the resulting residue is weighed. The result is reported as grams per 100 grams of brewed coffee. It will be recognized that the weighed residue may contain components that are soluble in the organic solvent, but are not “fats” in the scientific meaning of this term.

### B GC Fat

A sample of brewed coffee is injected into a gas chromatograph (“GC”). Components of the brewed coffee travel through a packed column in the gas chromatograph at different speeds, as a result of differences in volatility and differences in affinities to the column material. Coffee components leaving the column are detected by a detector located at the outlet of the column. This method permits qualitative analysis of the various components of the brewed coffee, based on their retention times within the column, and quantitative analysis of each component based on the integrated detection signal for each component.

It will be recognized that GC Fat analyzes fats that are true fats, and that are sufficiently volatile to be analyzable in a gas chromatograph. As a consequence the number for “GC Fat” should be expected to be lower than the number for “Total Fat”. Also, the number for “GC Fat” is believed to provide a better correlation to flavor components than does “Total Fat.”

Table 1 provides side-by-side comparisons of the fat contents of brewed coffee samples (fat contents are in g/100g):

TABLE 1

| | TOTAL | | FILTER |
|---|---|---|---|
| SAMPLE | FAT | GC FAT | MATERIAL |
| 12F46498-1 | 0.10 | 0.01 | Paper |
| 12F46498-2 | 0.15 | 0.02 | Nonwoven |
| 12F46498-3 | 0.18 | 0.01 | Paper |
| 12F46498-4 | 0.29 | 0.02 | Nonwoven |

Sample 12F46498-1 contains more Total Fat and more GC Fat than sample 12F46498-2. Sample 12F46498-3 contains more Total Fat and more GC Fat than sample 12F46498-4. Both samples brewed with a nonwoven polyolefin/polyester filter contain more GC Fat than the samples brewed with a conventional paper filter.

While the above description provides examples of one or more processes or apparatuses, it will be appreciated that other processes or apparatuses may be within the scope of the accompanying claims.

What is claimed is:

1. A single serve coffee capsule comprising a first chamber comprising ground roast coffee having an average particle size in the range of from 300 to 800 μm; and a second chamber; said first chamber being separated from the second chamber by a filter medium made of a synthetic polymeric material.

2. The single serve coffee capsule of claim 1 wherein the filter medium has an average pore size in the range of from 50 to 100 μm.

3. The single serve coffee capsule of claim 1 wherein the filter medium is a nonwoven web of synthetic fibers.

4. The single serve coffee capsule of claim 3 wherein the filter medium comprises polyolefin fibers.

5. The single serve capsule of claim 3 wherein the filter medium comprises polyolefin fibers and polyester fibers.

6. The single serve coffee capsule of claim 1 wherein the filter medium has a surface area A, the ground roast coffee has a weight W, and the ratio A/W is in the range of from 1-10 cm²/g.

7. The single serve capsule of claim 1 wherein the ratio A/W is in the range of from 3-7 cm²/g.

8. A process for brewing coffee using the single serve coffee capsule of claim 1, said process comprising passing hot water through the ground roast coffee during a brew time of from 20 to 90 seconds.

9. The process of claim 8 wherein the brew time is in the range of from 30 to 60 seconds.

10. The process of claim 8 wherein the hot water has a temperature in the range of from 90-95° C.

11. The process of claim 8 wherein, prior to passing the hot water, the ground roast coffee contains an amount of extractable solids, and the passing of the hot water results in 18 to 22% of the extractable solids being extracted.

12. The process of claim 8 resulting in coffee that meets an international standard for brewed coffee known as the SCAA Gold Cup Standard.

13. Coffee produced by the process of claim 8.
